(19) United States
(12) Patent Application Publication
(10) Pub. No.: US 2003/0131601 A1
(43) Pub. Date: Jul. 17, 2003

(54) Sliding steam temperature for combined cycle power plants

(75) Inventor: Geoff Baxter, Mohnton, PA (US)

Correspondence Address: David T. Bracken, The Law Office of David T. Bracken, 4839 Bond Avenue, Orange, CA, 92869, US

(73) Assignee: Parsons Energy & Chemicals Group, Inc.

(21) Appl. No.: 10/038,429

(22) Filed: Jan. 7, 2002

(51) Int. Cl. F02C 6/18

(52) U.S. Cl. 60/772; 60/39.182

(57) ABSTRACT

The present invention is a combined cycle power plant design increasing output and efficiency of heavily-fired combined cycle plants operating below the maximum output point by allowing the steam temperature to increase as the amount of duct firing is reduced. The cycle design also reduces the installed cost of the overall plant. Making steam temperature a variable in operating the power plant meets the problem of actual operation distancing itself from Carnot efficiency in reduced load or part load conditions.

### BACKGROUND OF THE INVENTION

The present invention relates to control systems and methods of operating combined cycle power plants. In 1971, a number of companies developed combined cycle power plants (CCPP) in package form. Westinghouse (now Siemens Westinghouse Power Corp.) developed a system called PACE (an acronym for Power At Combined Efficiencies). The GE system is called STAG (an acronym for Steam And Gas Turbines) and Stone and Webster Engineering Corp. has a combined cycle system called FAST. In 1999, GE, BBC now Asea Brown Boveri (ABB) and WEC, now part of Siemens, are joined by 20 more manufacturers of CCPP equipment. These plants can generate 60 Hz and 50 Hz electricity and are installed all over the world. The net plant output of these plants range from 2.65 MW to 786.9 MW. The simple combined cycle power plant consists of a single gas turbine-generator, heat recovery steam generator (HRSG), single steam turbine-generator, condenser and auxiliary systems.

There are two primary reasons why the efficiencies of operating combined cycle power plants are less than the Carnot efficiency. First, the temperature difference in the heat supplied to the cycle is very large. In a conventional steam plant, for example, the maximum steam temperature is about 810 degrees Kelvin (1,000 degrees Fahrenheit), while the combustion temperature in the boiler is about 2,000 K. (3,100 F.). The temperature of the waste heat from the process is higher than ambient temperature. Both exchange processes cause losses. The prior art predicts that improvement in this efficiency could be to reduce these losses by increasing the maximum temperature in the cycle or by releasing the rejected heat at the lowest temperature possible.

It is known that the thermal efficiency of gas turbines and combined cycle gas turbine-Rankine cycle engines is significantly reduced when they are operating at reduced loads. This reduction of efficiency is particularly evident when a constant drive speed is required, such as with electric generator service. Various mechanisms have been applied to gas turbines to remedy the part-power efficiency problem, such as multiple rotors, variable flow path geometry, cycle regeneration, and regenerator conditioning of turbine air streams, as described in U.S. Pat. No. 4,267,692.

Attempts to improve part-power efficiency of combined cycle gas turbine have been made with exhaust heat-driven steam Rankine bottoming cycle powerplants by selectively heating the compressor inlet air as the power level is reduced. The skilled person understands that changing turbine design is no small feat. The specific design of the turbine actually installed is determined by what a manufacturer is willing to provide—at a substantial price increase. Thus, the proposals for improving efficiency at reduced loads by changing turbine design typically fail to become practiced due to this barrier.

An object of the present invention is to provide a combined cycle powerplant which operates at high efficiency under part load conditions, and is an improvement over known powerplants.

### SUMMARY OF THE INVENTION

The present invention is a combined cycle power plant design increasing output and efficiency of heavily-fired combined cycle plants operating below the maximum output point by allowing the steam temperature to increase as the amount of duct firing is reduced. The cycle design also reduces the installed cost of the overall plant. Making steam temperature a variable in operating the power plant meets the problem of actual operation distancing itself from Carnot efficiency in reduced load or part load conditions.

It is well known in the art of combined cycle power plants that the steam pressure(s) change(s) in response to changes in the steam flow rate(s). The initiation of duct firing in the HRSG will always increase the steam flow. However, it has been an unwavering rule of control algorithms to restrict temperature of superheated steam leaving the HRSG for delivery to the turbine to at constant temperature. The practical concern in maintaining such a constant final superheat temperature has been that allowing such change would result in an excursion to a temperature/pressure region where the tubing would fail. The invention method increases the output and efficiency of a specific type of combined cycle plant by increasing the final steam superheat temperature at lower steam flow conditions therefore lower steam pressures, i.e., where it has been maintained at a constant temperature in the past. The specific type of cycle is one that has substantial duct firing in the HRSG coincident with decreased main steam temperature. An increased steam temperature is preferred during the peak firing of the combustion turbine generator (highest efficiency for that turbine) without duct burners operating. The concern for operating in a range of tubing failure for the invention method is essentially eliminated since a reduced operating pressure in the superheat tubes for the intermediate and high pressure steam levels exists at reduced steam plant output.

It is generally accepted that at reduced steam turbine output the cycle efficiency is increased when the steam pressure is allowed to drop following the steam flow rate. The present inventor has found that from a strength of materials perspective, increasing the steam temperature at reduced loads is possible because the maximum allowable superheated steam temperature for typical tubing material increases as the steam pressure decreases which is directly proportional to the reduction in steam flow. Thus, a retrofit of an existing plant is possible without changing expensive heat transfer coils or steam generators, as well as making it possible to accomplish the present invention in a grass roots plant with a single metallurgical specification.

This invention based on temperature variation is preferable for duct fired plants with a designed maximum efficiency in the non-duct burner fired, peak CGT fired mode. The maximum allowable superheated steam temperature increases as the saturated steam generation pressure decreases following the allowable pressure temperature values for the steam conduit material. The added cost for this operation will be minimal since the boiler tubes, steam piping and steam turbine materials are not changed from the original design. In fact the overall installed cost will decrease as a result of the lower required superheater steam temperatures at full duct firing.

Heavily fired combined cycle plants are developed to take advantage of very high peak electricity sales rates, up to 100 times the normal amount paid for electrical generation. However, a plant designed for peak efficiency at peak firing of its CGT(s) that also has duct burners for substantial duct firing must have a steam turbine generator with a steam path designed for the steam flow rate at full duct firing. Such a steam turbine will have a lower efficiency at non-duct fired conditions than a smaller steam turbine at the same non-duct fired conditions. Therefore a heavily duct fired plant has a necessarily lower efficiency even at its highest efficiency point (unfired operation) than plants designed with no duct firing. This decreased peak efficiency makes the plant less competitive in almost all modes of operation. This invention will increase the peak efficiency of duct fired plants to make them more competitive.

From an initial capital cost prospective, plants designed for peak electrical generation typically have a lower installed cost per kilowatt than continuously operated plants that must operate in off peak periods. Therefore it is beneficial for duct fired plants to be designed with lower superheated steam temperature conditions from the HRSG since the installed cost increases as that steam temperature increases. Although lowering the superheated steam temperature from the HRSG lowers the plant output per pound of steam ratio, the reduction in output can be recovered by increasing the amount of duct firing. Therefore designing the steam cycle with a lower superheated steam temperature from the HRSG for a peak fired CGT and allowing the steam temperature to rise as the load is decreased is an optimal design for a heavily fired plant.

One reason this type of cycle has not been invented before is that heavily fired combined cycle plants designed for peaking generation are just now being developed. Therefore little emphasis has been placed on investigating this type of process in the past. In addition this type of cycle is most preferable for duct fired plants interested in maximizing efficiency in lower output modes, which previously has not been considered an important operating condition. To date, the industry's experience in heavily fired HRSG's has been mostly for cogeneration plants with constant steam pressures and temperatures due to the needs of the process served.

### BRIEF DESCRIPTION OF THE DRAWINGS

FIG. 1 is a flow diagram of a combined cycle power plant for the method of the invention.

FIG. 2 is a chart comparing cycle efficiency by adjusting duct burner duty from a specific example of a prior art combined cycle plant operated with the prior art method and the invention method.

FIG. 3 is a chart comparing absolute and differential megawatt outputs from a specific example of a prior art combined cycle plant operated with the prior art method and the invention method.

FIG. 4 is a chart showing the changes in final superheat temperature for high pressure steam for the invention method with changing duct burner duty as further compared with a graph of the prior art control algorithm for changing high pressure steam pressure with such a change in duct burner duty (and maintaining a single steam temperature as in the prior art) from a specific example of a prior art combined cycle plant operated with the prior art method and the invention method.

FIG. 5 shows the application of the operation range shown in FIG. 4 for the prior art constant temperature and the invention increased temperatures as compared with the graph of maximum pressure and temperature rating for P91 Sch. 140 pipe, demonstrating that the invention method maintains safe operating ranges for the high pressure steam tubing in the superheater coils (based on ASME 31.1 Power Piping Code).

### DETAILED DESCRIPTION OF THE INVENTION

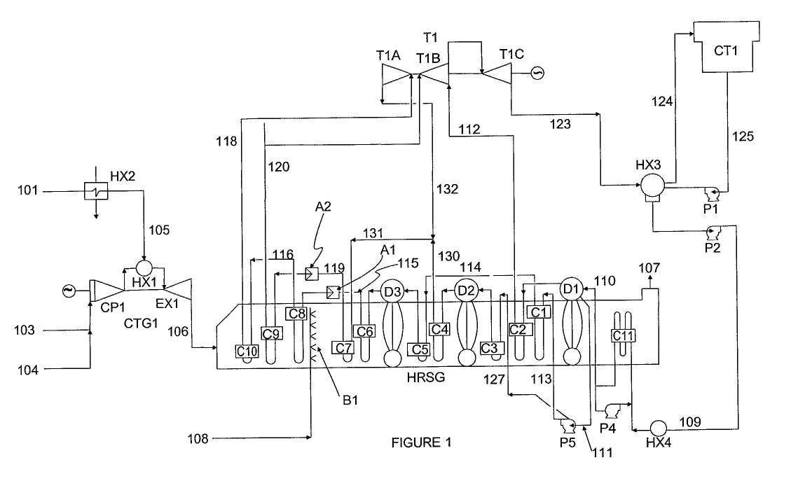

FIG. 1 shows a combined cycle power plant with a combustion turbine generator CTG1, a steam turbine generator T1, and a heat recovery steam generator device HRSG integrated to accomplish the objects of the present invention. A fuel gas is fed in stream 101, heated in exchanger HX2 and combusted as stream 105 in combustor HX1 with inlet air stream 103 (optionally with a fogger cooler stream 104) from compressor stage CP1. The exhaust stream from combustor HX1 is expanded in expander stage EX1 to form stream 106 to device HRSG, from which heat is recovered to water and steam in recovery coils C1-C11 and steam generators D1-D3, whereafter the gas is exhausted to a stack as stream 107.

Steam condensate and make-up water is drawn from exchanger HX3, pumped to Aft desired pressure in pump P2, heated in gland steam condenser exchanger HX4 and fed to condensate heater coils C11. A recycle means in pump P4 is provided about coils C11. The stream 110 heated in coils C11 is fed to the low pressure steam generator D1, producing a heated water stream 111 and a low pressure steam stream heated in low pressure steam superheater coils C2 to form stream 112. The superheated low pressure steam of stream 112 is fed to steam turbine generator T1 to mix with the effluent of the expander stage T1B, which forms the feed to expander stage T1C, the exhaust stream 123 therefrom is condensed in condenser exchanger HX3. Exchanger HX3 is preferably connected with a cooling tower CT1 as its indirect condensing medium.

Stream 111 is raised to two different pressure streams, high pressure steam stream 113 and Hot Reheat level steam stream 127. Stream 113 is fed to economizer coils C1 emerging as stream 114 and then to economizer coils C5 before being fed to generator D3 to produce a saturated high pressure steam which is superheated in superheater coils C6 downstream of the duct burners B1 (fired with fuel gas from stream 108). The superheated steam from coils C6 form stream 115 which is fed to attemperator A1 for optional temperature reduction by liquid water injection. Effluent from attemperator A1 is superheated in superheater coils C8 & C10, the effluent of which is sent to expander steam stream 118. Attemperator A1 controls the temperature of stream 118. The high pressure stream 118 expands through STG T1A and exits as cold reheat stream 132. Stream 132 is mixed with superheated intermediate pressure stream 130 becoming stream 131. This mixed stream is heated in superheater coil C7, the effluent stream 119 is fed to attemperator A2 before final superheating in superheater coils C9 to form hot reheat stream 120. Attemperator A2 controls the temperature of stream 120. Hot reheat stream 120 is expanded in STG T1B and exits into STG T1C.

Stream 127 is heated in economizer coils C5 before feeding intermediate steam pressure generator D2, the steam effluent of which is superheated in superheater coils C4 for form stream 130.

It is apparent from the present description that the coils C8-C10 are located in increasing temperature sequence upstream of the duct burners B1 and that the rest of the heat recovery coils are located downstream therefrom in the decreasing temperature sequence of heat recovery transfer devices C7, C6, D3, C5, C4, D2, C3, C2, C1, D1 and C1.

Specific examples of the operation of the method of the present invention are shown in the Tables 1 and 2 below comparing two case where two generators CTG1 operate at peak load with and without full duct burner 1 firing. The information provided therein is preliminary and based on typical efficiencies and flows for a combined cycle plant. Specific equipment may operate with substantially different output and still obtain the benefits of the invention method. Case 1 results are for a typical combined cycle plant where the duct burners are fully fired, i.e., where the invention method and the prior art method produce substantially the same final superheated steam temperatures. Case 2 shows results for a typical combined cycle plant where the duct burners not fired, i.e., where the invention method shows a substantial improvement over the prior art method of maintaining the same final superheated steam temperature to the steam turbines. Table 2 shows a comparison of Net Plant Heat Rates where the invention method in Case 2 (using about 50 degrees F. higher temperatures for streams 118 and 120) results in about a 10% improvement over the value in Case 1. This improvement can actually increase depending on the rating of specific tubing used at the superheater coils in the HRSG.

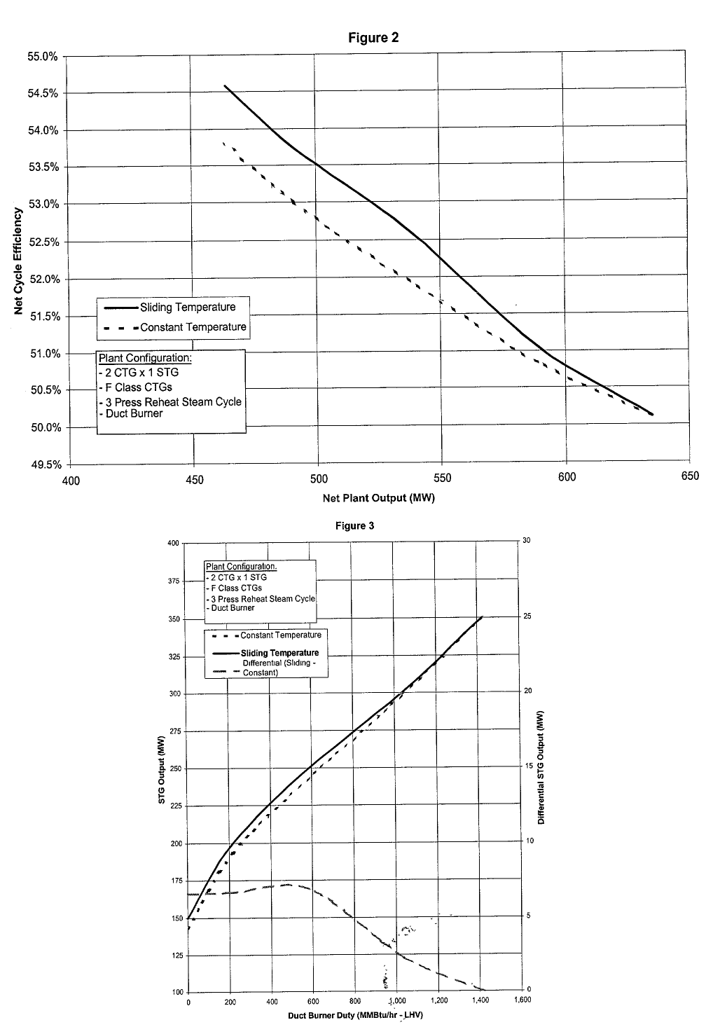

FIGS. 2-5 are each clear demonstrations of the improvement of the invention method over the prior art method of operation.

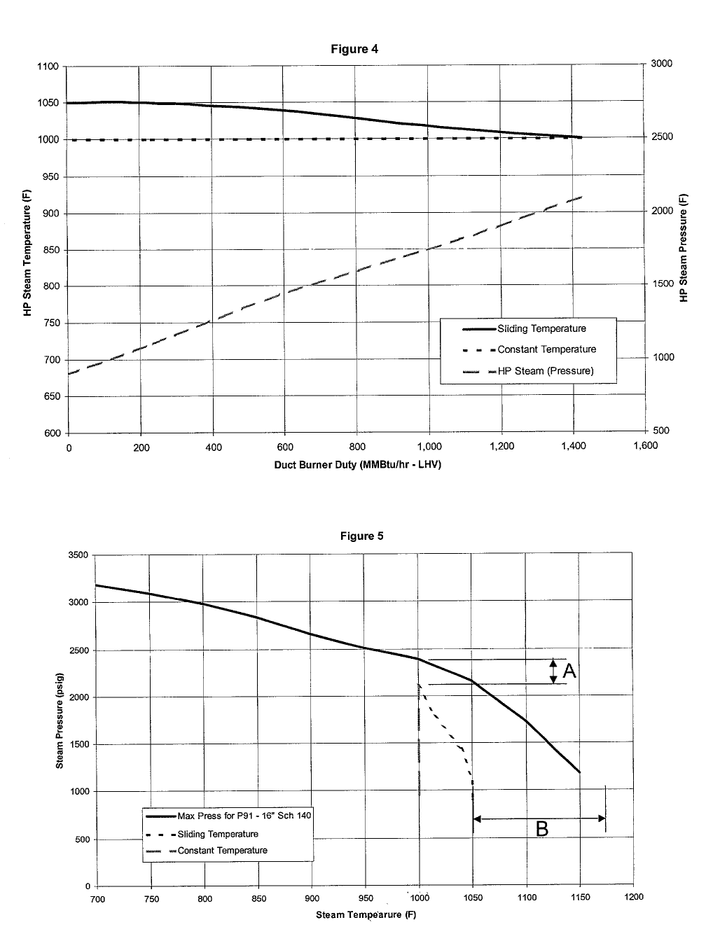

As described above, the prior art method of maintaining a single temperature for the final superheat temperature regardless of pressure level is shown clearly in FIGS. 4 and 5 as straight operating lines titled “Constant Temperature”. The invention method, by contrast, increases in FIGS. 4 and 5 (shown as the operating line titled “Sliding Temperature”) from about the same temperature as that of the Constant Temperature at full duct firing rate of just over 1.4 MMBtu/hr to about 50 degrees F. higher where than the Constant Temperature line where duct burner firing is reduced to zero. Comparison of FIGS. 4 and 5 clearly show that the Sliding Temperature operating line is never unacceptably close to the maximum pressure and temperature rating line for an acceptable superheater coil tubing for coils in the positions of coils C8-C10. It will be appreciated that the minimum temperature differential A required for safety at the highest steam pressure in full duct firing is clearly maintained at the increased final superheated steam temperature of the invention method at temperature differential B. Differential B is shown as exemplary for turbines of a particular type with a maximum inlet temperature. Differential B can be greatly reduced, i.e., the final superheat temperature can be relatively greatly increased from the range of no duct firing to about 40% maximum duct firing without reaching the safe operability limits of the superheater coil tubing in the specific example. The skilled person will appreciate that the graph of the specific tubing of FIG. 5 is exemplary and that the benefits of the invention method may be obtained with other specific metallurgy and tubing thickness. FIGS. 2 and 3 best illustrate the invention method improvement (shown as the lines titled “Sliding Temperature”) over the prior art method of constant temperature (shown as the lines titled “Constant Temperature”). Net cycle efficiency improves for all parts of the operational line for the invention method over the prior art method until full duct firing occurs. The differential STG output in MW is shown in FIG. 3 compared with the application of duct firing for a specific example and demonstrates a substantially constantly better output for the same level of duct firing for the invention method over the prior art method for from about zero to 40 percent of full duct firing. The invention method preferably uses attemperators in positions such as those shown in FIG. 1 for steam flows to coils C8-C10 to control the final superheated steam temperatures to accomplish the objects of the invention. The retrofit to the control system of a combined cycle plant is relatively simple in that the attemperator would be operated to control the temperatures of streams 118 and 120 to desired temperatures. Other control methods are possible and are within skill in the art with the present disclosure.

The above design options will sometimes present the skilled designer with considerable and wide ranges from which to choose appropriate apparatus and method modifications for the above examples. However, the objects of the present invention will still be obtained by that skilled designer applying such design options in an appropriate manner.

TABLE 1
CASE No. 1 - 100° F./46% RH, Gas Operation, CTG1's at base load, Max Duct Firing.
CASE No. 2 - 100° F./45% RH, Gas Operation, CTG1's at base load, No Duct Firing.

| | |
|---|---|
| Case 1 | Case 2 |

| Stream | | Flow | Temp | Press | Flow | Temp | Press |
|---|---|---|---|---|---|---|---|
| Number | Description | (lb/hr) | (° F.) | (psia) | (lb/hr) | (° F.) | (psia) |
| 105 | CTG Fuel After Heater | 67,393 | 350 | | 67,393 | 374 | |
| 108 | Duct Bumer Fuel | 33,411 | 50 | | 0 | | |
| | Total Fuel Consumed | 201,608 | | | 134,787 | | |
| 106 | CTG Exhaust | 3,221,002 | 1,149 | | 3,221,002 | 1,149 | |
| B1 | Duct Burner Exit | | 1,682 | | | 979 | |
| 107 | HRSG Stack Exit | 3,254,412 | 181 | | 3,221,002 | 194 | |
| 118 | HP Steam from HRSG | 956,097 | 1,003 | 2,180 | 397,937 | 1,053 | 959 |
| 120 | HRH Steam from HRSG | 966,769 | 1,003 | 459 | 472, 676 | 1,053 | 230 |
| 132 | CRHSteam to HRSG | 950,078 | 615 | 479 | 395,142 | 697 | 239 |
| | IP Steam Generation | 16,271 | 480 | 479 | 53,938 | 449 | 239 |
| 112 | LP Steam from HRSG | 0 | | | 46,095 | 357 | 48 |
| 109 | Condensate to HRSG | 972,771 | 126 | 81 | 521,566 | 107 | 51 |
| 118 (×2) | HP Steam to STG | 1,912,186 | 1,000 | 2,115 | 795, 874 | 1,050 | 930 |
| 120 (×2) | HRH Steam to STG | 1,933,513 | 1,000 | 440 | 945, 351 | 1,050 | 220 |
| 133 | CRH Steam from STG | 1,900,157 | 617 | 490 | 790, 283 | 699 | 243 |
| 112 (×2) | LP Steam to STG | 0 | | | 92,190 | 356 | 45 |
| 123 | STG Exhaust | 1,944,541 | 125 | 1.96 | 1,042,132 | 107 | 1.16 |
| 109 | Condenser Hotwell | 1,945,541 | 125 | 1.96 | 1,943,132 | 107 | 1.16 |
| 131 | CRH to Auxilary Steam Header | 1,000 | 617 | 490 | 1,000 | 699 | 243 |
| 129 | IP Feedwater to Fuel Heater | 31,902 | 462 | 479 | 92,500 | 374 | 242 |
| A2 | HP HRSG Attemperator | 375 | 315 | | 16,267 | 290 | |
| A1 | HRH HRSG Attemperator | 419 | 310 | | 23,596 | 282 | |

TABLE 2

| PLANT OUTPUT SUMMARY | Case 1 | Case 2 |
|---|---|---|
| CTG Output Unit No. 1 - (kW) | 150,100 | 150,100 |
| CTG Output Unit No. 2 - (kW) | 150,100 | 150,100 |
| STG Output - (kW) | 349,826 | 174,289 |
| Duct Burner Duty per HRSG | 718.8 | |
| (MMBtu/hr LHV) | | |
| Plant Output @ Gen Term (kW) | 650,026 | 474,489 |
| Auxiliary Losses (kW) | (13,001) | (9,490) |
| Net Plant Electrical Output (kW) | 637,026 | 464,999 |
| Cycle Heat Input (Million Btu/hr) HHV | 4,771.3 | 3,189.9 |
| Net Plant Heat Rate (Btu/kWh) HHV | 7,490 | 6,860 |

I claim:

1. A method for operation of a combined cycle power plant comprising:
(a) a combustion turbine generator generating electricity, forming a high temperature exhaust stream fed to a heat recovery steam generator;
(b) the heat recovery steam generator comprising heat transfer coils recovering heat from the exhaust stream and optionally duct burner fluegas from duct burner operation, such heat recovery generating streams of low pressure steam, intermediate pressure steam, and high pressure steam where duct burner fluegas is introduced downstream of at least one coil for superheating high pressure steam or intermediate pressure steam just prior to their introduction into a steam turbine;
(c) one or more steam turbine generators generating electricity from the superheated steam streams of the heat recovery steam generator; and
(d) operating the plant in a first mode-so that the duct burners are substantially firing at full capacity such that the final superheated steam temperatures are at a first and lower temperature level; and
(e) operating the plant in a second mode so that the duct burners are substantially firing at less than full capacity such that the final superheated steam temperatures are substantially higher than the first and lower temperature level.

2. The method of claim 1 wherein the streams for high pressure steam and intermediate pressure steam are heated to their final superheated temperatures in coils downstream of the introduction of duct burner fluegas.

3. The method of claim 1 wherein the final superheat temperatures are controlled by injection of liquid water into the superheated steam streams.

4. The method of claim 1 wherein the second mode of operation includes no duct burner firing.

5. The method of claim 1 wherein the second mode of operation includes no duct burner firing and operating the combustion turbine at a lower rate than that required for its highest efficiency such that the exhaust is at a substantially higher temperature than the highest efficiency operation.

6. The method of claim 1 wherein the second mode of operation results in final superheated steam temperatures at least 20 degrees F. higher than the first and lower temperature level.

7. The method of claim 1 wherein the second mode of operation results in final superheated steam temperatures at least 50 degrees F. higher than the first and lower temperature level.

8. The method of claim 1 wherein the second mode of operation results in final superheated steam temperatures at least 60 degrees F. higher than the first and lower temperature level.
